(19) United States
(12) Patent Application Publication
(10) Pub. No.: US 2026/0023708 A1
(43) Pub. Date: Jan. 22, 2026

(54) HUB AND ELECTRONIC DEVICE

(71) Applicant: REALTEK SEMICONDUCTOR CORP., Hsinchu (TW)

(72) Inventor: Jian-Jhong Zeng, Hsinchu (TW)

(73) Assignee: REALTEK SEMICONDUCTOR CORP., Hsinchu (TW)

(21) Appl. No.: 18/936,282

(22) Filed: Nov. 4, 2024

(30) Foreign Application Priority Data
Jul. 19, 2024 (TW) 113127231

(51) Int. Cl. G06F 13/40

(52) U.S. Cl. CPC G06F 13/4068; G06F 2213/40

(57) ABSTRACT

A hub includes a first up-stream port (USP), a second USP, a down-stream port (DSP), a first control unit, and a second control unit. The first USP is configured to connect to a first electronic device. The second USP is configured to connect to a second electronic device. The DSP is configured to connect to a third electronic device. The first control unit is connected to the first USP and the DSP, to select whether to bring the DSP into data communication with the first USP. The second control unit is connected to the second USP and the DSP, to select whether to bring the DSP into data communication with the second USP.

### CROSS-REFERENCE TO RELATED APPLICATION

This non-provisional application claims priority under 35 U.S.C. § 119 (a) to patent application No. 113127231 filed in Taiwan, R.O.C. on Jul. 19, 2024, the entire contents of which are hereby incorporated by reference.

### BACKGROUND

### Technical Field

The present disclosure relates to electronic devices, and in particular, to a hub and an electronic device.

### Related Art

A hub is an information transmission device, which may serve as a node to implement one-to-many information transmission. For example, information transmission may be realized between a headset, a keyboard, a mouse, or a flash drive and a computer host through the hub.

However, a typical hub has only a single up-stream port (USP) and a plurality of down-stream ports (DSPs). In other words, only one computer host can form an information connection with the headset, the keyboard, the mouse, and the flash drive through the hub, causing inconvenience in use.

### SUMMARY

In some embodiments, a hub includes a first up-stream port (USP), a second USP, a down-stream port (DSP), a first control unit, and a second control unit. The first USP is configured to connect to a first electronic device. The second USP is configured to connect to a second electronic device. The DSP is configured to connect to a third electronic device. The first control unit is connected to the first USP and the DSP, to select whether to bring the DSP into data communication with the first USP. The second control unit is connected to the second USP and the DSP, to select whether to bring the DSP into data communication with the second USP.

In some embodiments, the first USP is configured to receive a setting instruction from the first electronic device, and the first control unit is configured to select, based on the setting instruction, whether to bring the DSP into data communication with the first USP.

In some embodiments, the second USP is configured to receive a setting instruction from the second electronic device, and the second control unit is configured to select, based on the setting instruction, whether to bring the DSP into data communication with the second USP.

In some embodiments, each of the first control unit and the second control unit includes a media access control circuit and a physical layer transceiver connected to each other.

In some embodiments, in the first control unit, the media access control circuit is configured to control, based on the setting instruction, the physical layer transceiver to receive and transmit data through the first USP and the DSP selected by the first control unit.

In some embodiments, in the second control unit, the media access control circuit is configured to control, based on the setting instruction, the physical layer transceiver to receive and transmit data through the second USP and the DSP selected by the second control unit.

In some embodiments, the number of DSP is multiple. The first control unit is configured to select to bring at least one of the DSPs into data communication with the first USP. The second control unit is configured to select to bring each of the remaining DSPs into data communication with the second USP.

In some embodiments, an electronic device includes an electronic device body, a first USP, a second USP, a DSP, a first control unit, and a second control unit. The first USP is embedded in the electronic device body, and is configured to connect to a first electronic device. The second USP is embedded in the electronic device body, and is configured to connect to a second electronic device. The DSP is embedded in the electronic device body, and is configured to connect to a third electronic device. The first control unit is located in the electronic device body and connected to the first USP and each DSP, to select whether to bring the DSP into data communication with the first USP. The second control unit is located in the electronic device body and connected to the second USP and the DSP, to select whether to bring the DSP into data communication with the second USP.

Based on the above, the hub of any embodiment and the electronic device can enable a plurality of electronic devices (for example, the first electronic device or the second electronic device) to share the plurality of DSPs through the same hub and then to be brought into data communication with a plurality of other electronic devices (for example, the third electronic device) through the plurality of DSPs.

### BRIEF DESCRIPTION OF THE DRAWINGS

FIG. 1 is a functional block diagram of a hub according to an embodiment.

FIG. 2 is a schematic diagram of an electronic device according to an embodiment.

### DETAILED DESCRIPTION

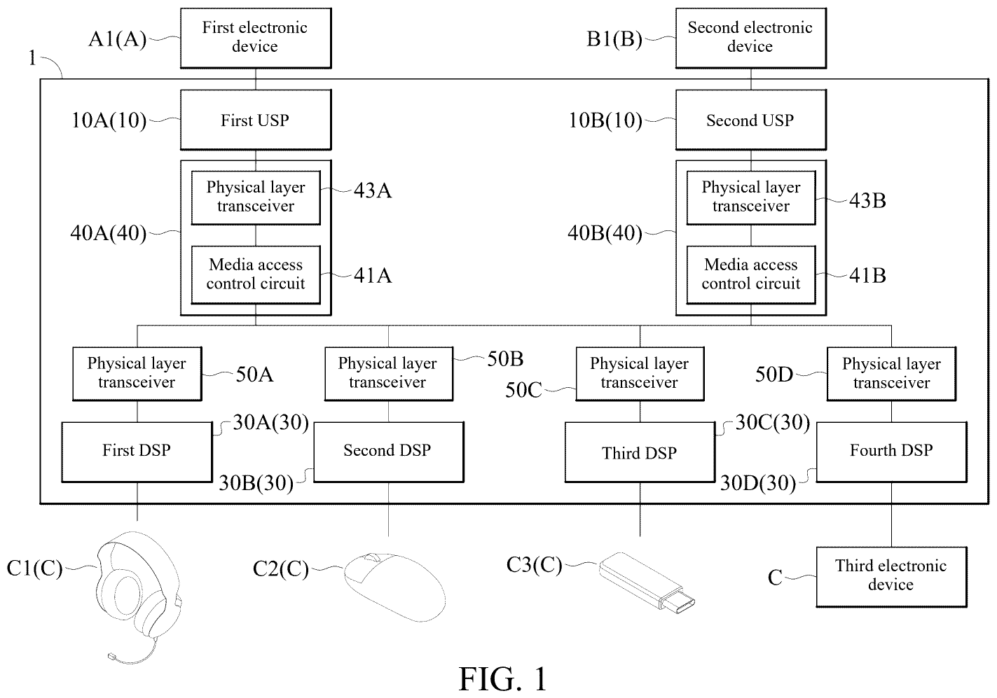

Referring to FIG. 1, a hub 1 includes a plurality of up-stream ports (USPs) 10, a plurality of down-stream port (DSP) 30, and a plurality of control units 40. Each of the USPs 10 is adapted to externally connect to an electronic device (for example, a first electronic device A or a second electronic device B). Each of the DSP 30 is adapted to externally connect to another electronic device (for example, a third electronic device C). The USPs 10 correspond to the control units 40 in a one-to-one manner, and each control unit 40 is configured to control a communication connection between the corresponding USP 10 and the corresponding DSP 30. In addition, in some embodiments, the number of DSP 30 is not limited to one and may be more than one. As shown in the figure, in the present disclosure, an example in which four DSPs 30 are used for description.

In some embodiments, each USP 10 may be a USB 2.0 port, a USB 3.x port, a USB 4.0 port, or a USB type-C port. The DSP 30 may be a USB 2.0 port, a USB 3.x port, a USB 4.0 port, a USB type-C port, a secure digital (SD) port, high-definition multimedia interface ports (HDMI ports), a video graphics array (VGA) port, a 3.5 mm audio jack, a fiber optic audio jack, an RJ45 port, or the like. Each electronic device A, B, or C may be an independent device or a peripheral device. The independent device may be for example a desktop computer, a notebook computer, a smart television, a host, or a server. The peripheral device may be for example a headset, a mouse, a keyboard, a speaker, a flash drive, a display, a charging base, or an expansion base. In some embodiments, the USP 10 and the DSP 30 in the communication connection may be the independent devices and the peripheral devices.

For clarity, a 2-to-4 hub 1 is used as an example. The hub 1 is provided with 2 USPs 10 (referred to as a first USP 10A and a second USP 10B below), 2 control units 40 (referred to as a first control unit 40A and a second control unit 40B below), and 4 DSPs 30 (referred to as a first DSP 30A, a second DSP 30B, a third DSP 30C, and a fourth DSP 30D below). The first USP 10A is configured to connect to the first electronic device A, and the second USP 10B is configured to connect to the second electronic device B.

The first control unit 40A is connected to the first USP 10A and each DSP 30. The first control unit 40A is configured to select whether to bring each DSP 30 into data communication with the first USP 10A. In other words, the first control unit 40A may select to bring none of the DSPs 30 into data communication with the first USP 10A. The first control unit 40A may also select to bring more than one DSP 30 into data communication with the first USP 10A, and even the first control unit 40A may also select to bring all of the DSPs 30 into data communication with the first USP 10A.

The second control unit 40B is connected to the second USP 10B and each DSP 30. The second control unit 40B is configured to select to bring the remaining DSPs 30 into data communication with the second USP 10B. To be specific, the DSP 30 selected by the second control unit 40B is not a duplicate of the DSP 30 selected by the first control unit 40A. For example, as shown in the figure, when the number of DSP 30 is four, and when the first control unit 40A selects to bring none of the DSPs 30A, 30B, 30C, and 30D into data communication with the first USP 10A, the second control unit 40B selects to bring all of the DSPs 30A, 30B, 30C, and 30D into data communication with the second USP 10B. When the first control unit 40A selects to bring the first DSP 30A and the second DSP 30B into data communication with the first USP 10A, the second control unit 40B selects to bring the remaining third DSP 30C and the remaining fourth DSP 30D into data communication with the second USP 10B. For another example, when the first control unit 40A selects to bring the first DSP 30A into data communication with the first USP 10A, the second control unit 40B selects to bring the remaining second DSP 30B, the remaining third DSP 30C, and the remaining fourth DSP 30D into data communication with the second USP 10B. When the first control unit 40A selects to bring all of the DSPs 30A, 30B, 30C, and 30D into data communication with the first USP 10A, none of the DSPs 30A, 30B, 30C, and 30D are brought into data communication with the second USP 10B.

In some embodiments, that the first control unit 40A selects whether to bring each DSP 30 into data communication with the first USP 10A is set in a factory. To be specific, a data communication relationship between the DSP 30 and the first USP 10A has been set in advance during manufacturing of the hub 1. For example, when the hub 1 is manufactured in the factory, the first control unit 40A is set to select to bring the first DSP 30A and the second DSP 30B into data communication with the first USP 10A.

In some embodiments, the first USP 10A is configured to receive a setting instruction from the first electronic device A, and the first control unit 40A is configured to select, based on the setting instruction, whether to bring the first USP 10A into data communication with the DSP 30. In some embodiments, the data communication relationship between the DSP 30 and the first USP 10A is set by using the first electronic device A through software and the setting instruction. For example, the first electronic device A installs setting software, and a user transmits the setting instruction to the first control unit 40A based on the setting software, so that the first control unit 40A selects, based on the setting instruction, to bring the first DSP 30A and the second DSP 30B into data communication with the first USP 10A. In this way, the user may adjust the data communication relationship among the first USP 10A, the second USP 10B, and the DSP 30 as required. In some embodiments, the second USP 10B is configured to receive a setting instruction from the second electronic device B, and the second control unit 40B is configured to select, based on the setting instruction, whether to bring the second USP 10B into data communication with the DSP 30. In some embodiments, the first control unit 40A is in data communication with the second control unit 40B, so that the first control unit 40A and the second control unit 40B jointly control the data communication relationship between the first USP 10A and the second USP 10B and each DSP 30 based on the setting instruction. For example, the first control unit 40A controls, based on the setting instruction, the first USP 10A to be brought into data communication with the first DSP 30A and the second DSP 30B, and the second control unit 40B controls the second USP 10B to be brought into data communication with the third DSP 30C and the fourth DSP 30D based on the setting instruction. In some embodiments, the first USP 10A receives setting instruction through General-purpose input/output (GPIO), Inter-Integrated Circuit (I2C), or System Management Bus (SMBUS).

FIG. 1 additionally shows a schematic diagram of a usage state of the hub 1. The first DSP 30A is connected to a headset C1. The second DSP 30B is connected to a mouse C2. The third DSP 30C is connected to a flash drive C3. The fourth DSP 30D is not connected to the electronic device. The first USP 10A is connected to a desktop computer A1. The second USP 10B connected to a notebook computer B1. The first control unit 40A is set to select to bring the first DSP 30A and the third DSP 30C into data communication with the first USP 10A. The second control unit 40B is set to select to bring the second DSP 30B and the fourth DSP 30D into data communication with the second USP 10B. In the usage state, when the user operates the desktop computer A1, data of the flash drive C3 may be sequentially transmitted to the desktop computer A1 via the third DSP 30C, the first control unit 40A, and the first USP 10A through the hub 1. Alternatively, the data is sequentially stored in the flash drive C3 via the first USP 10A, the first control unit 40A, and the third DSP 30C. Similarly, the desktop computer A1 may also control the headset C1 to operate through the hub 1. Moreover, the principle in which the mouse C2 controls the notebook computer B1 through the hub 1 is similar, and details are not described again. In this way, through the hub 1, the desktop computer A1 and the notebook computer B1 may be enabled to share a same hub 1 to be brought into data communication with the headset C1, the mouse C2, and the flash drive C3.

Referring to FIG. 1, in some embodiments, each of the first control unit 40A and the second control unit 40B includes media access control circuits 41A and 41B and physical layer transceivers 43A and 43B connected to each other. Moreover, in some embodiments, the hub 1 further includes a physical layer transceiver 50A, a physical layer transceiver 50B, a physical layer transceiver 50C, and a physical layer transceiver 50D. The physical layer transceiver 50A is connected to the first DSP 30A. The physical layer transceiver 50B is connected to the second DSP 30B. The physical layer transceiver 50C is connected to the third DSP 30C. The physical layer transceiver 50D is connected to the fourth DSP 30D. The first control unit 40A and the second control unit 40B are respectively connected to the first DSP 30A, the second DSP 30B, the third DSP 30C, and the fourth DSP 30D through the physical layer transceiver 50A, the physical layer transceiver 50B, the physical layer transceiver 50C, and the physical layer transceiver 50D. Functions of the media access control circuits 41A and 41B include: (I) data frame processing, responsible for generation, sending, and transmission of the data frame, where the data frame includes a header and a verification code, to ensure that the data is not tampered with or corrupted during transmission; (II) flow control, configured to control a priority of data transmission and bandwidth allocation, to ensure that data transmission between different devices does not interfere with each other; (III) protocol processing, configured to ensure that communication between the devices follows the USB protocol specification; and (IV) device addressing and identification, configured to ensure that the data can be correctly transmitted to a target device. Functions of the physical layer transceivers 43A, 43B, 50A, 50B, 50C, and 50D include signal transmission and reception (for example, receiving a signal from the DSP 30 or transmitting a signal to the DSP 30), and detecting whether the DSP 30 is connected to the third electronic device C. In this way, the data communication relationship among the first USP 10A, the second USP 10B, and the DSP 30 is selected through the cooperation between the media access control circuits 41A and 41B and the physical layer transceivers 43A and 43B. For example, when the first control unit 40A sets the first USP 10A to communicate data with the first DSP 30A and the second DSP 30B, the media access control circuit 41A receives data from the first DSP 30A and the second DSP 30B through the physical layer transceivers 50A and 50B, without receiving data from the third DSP 30C and the fourth DSP 30D, and transmits the data to the first USP 10A through the physical layer transceiver 43A. Alternatively, the media access control circuit 41A receives data from the first USP 10A through the physical layer transceiver 43A, and transmits the data to the first DSP 30A and the second DSP 30B through the physical layer transceivers 50A and 50B, without transmitting to the third DSP 30C and the fourth DSP 30D. In addition, the media access control circuit 41B controls the physical layer transceiver 43B in a similar manner, and details are not described again.

In some embodiments, in the first control unit 40A, the media access control circuit 41A is configured to control, based on the setting instruction, the physical layer transceiver 43A, 50A, 50B, 50C and 50D to receive and transmit data through the first USP 10A and the DSP 30 selected by the first control unit 40A. In other words, when the setting instruction specifies the first DSP 30A and the second DSP 30B, the first USP 10A is configured to receive the setting instruction from the first electronic device A, and the media access control circuit 41A is configured to control, based on the setting instruction, the physical layer transceiver 50A and 50B to receive the data only from the first DSP 30A and the second DSP 30B or to transmit the data only to the first DSP 30A and the second DSP 30B. In some embodiments, in the second control unit 40B, the media access control circuit 41B is configured to control, based on the setting instruction, the physical layer transceiver 43B, 50A, 50B, 50C and 50D to receive and transmit data through the second USP 10B and the DSP 30 selected by the second control unit 40B. For the embodiment, reference is made to the foregoing description, and details are not described herein again.

In some embodiments, the media access control circuit 41A and the physical layer transceiver 43A are integrated in a same chip, and the media access control circuit 41B and the physical layer transceiver 43B are integrated in a same chip. In this way, communication and data transmission efficiency between the media access control circuits 41A and 41B and the physical layer transceivers 43A and 43B may be improved, the design of the hub may be simplified, and performance and stability of the hub may be improved.

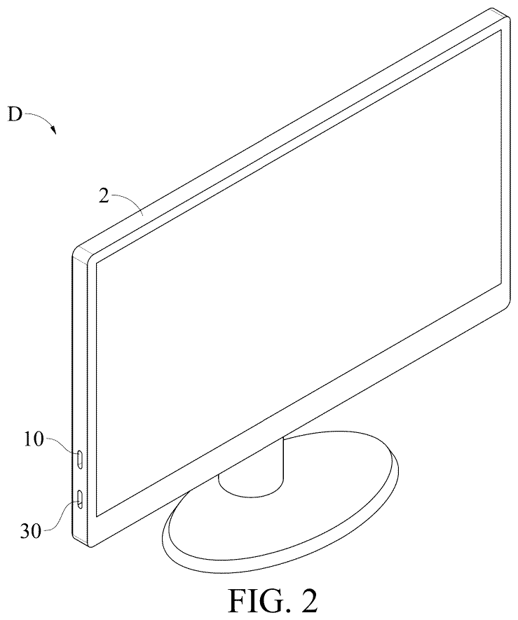

Referring to FIG. 2, in some embodiments, the hub 1 may also be built into an electronic device (referred to as a fourth electronic device D below). Specifically, the fourth electronic device D includes the hub 1 according to any of the foregoing embodiments and an electronic device body 2. Each control unit 40 (for example, a first control unit 40A and a second control unit 40B) is located in the electronic device body 2. In addition, each USP 10 (for example, a first USP 10A and a second USP 10B) and each DSP 30 are embedded in the electronic device body 2. For example, the first control unit 40A and the second control unit 40B are arranged on a main board of the electronic device body 2. In addition, the first USP 10A, the second USP 10B, and each DSP 30 are exposed from an outer housing of the electronic device body 2.

For example, in some embodiments, the first USP 10A or the second USP 10B of the hub 1 is connected to the electronic device body 2.

Based on the above, the hub 1 of any embodiment and the electronic device can enable a plurality of electronic devices (for example, the first electronic device A or the second electronic device B) to share the plurality of DSPs 30 through the same hub and then to be brought into data communication with a plurality of other electronic devices (for example, the third electronic device C) through the plurality of DSPs 30. In some embodiments, the hub 1 or the electronic device may further transmit the setting instruction through software to change the data communication relationship among the first USP 10A, the second USP 10B, and the plurality of DSPs 30.

What is claimed is:

1. A hub, comprising:
a first up-stream port (USP), configured to connect to a first electronic device;
a second USP, configured to connect to a second electronic device;
a down-stream port (DSP), configured to connect to a third electronic device;
a first control unit, connected to the first USP and the DSP, to select whether to bring the DSP into data communication with the first USP; and
a second control unit, connected to the second USP and the DSP, to select whether to bring the DSP into data communication with the second USP.

2. The hub according to claim 1, wherein the first USP is configured to receive a setting instruction from the first electronic device, and the first control unit is configured to select, based on the setting instruction, whether to bring the DSP into data communication with the first USP.

3. The hub according to claim 1, wherein the second USP is configured to receive a setting instruction from the second electronic device, and the second control unit is configured to select, based on the setting instruction, whether to bring the DSP into data communication with the second USP.

4. The hub according to claim 1, wherein each of the first control unit and the second control unit comprises a media access control circuit and a physical layer transceiver connected to each other.

5. The hub according to claim 4, wherein in the first control unit, the media access control circuit is configured to control, based on a setting instruction, the physical layer transceiver to receive and transmit data through the first USP and the DSP selected by the first control unit.

6. The hub according to claim 4, wherein in the second control unit, the media access control circuit is configured to control, based on a setting instruction, the physical layer transceiver to receive and transmit data through the second USP and the DSP selected by the second control unit.

7. The hub according to claim 1, wherein the number of DSP is multiple, the first control unit is configured to select to bring at least one of the DSPs into data communication with the first USP, and the second control unit is configured to select to bring the remaining DSPs into data communication with the second USP.

8. An electronic device, comprising:
an electronic device body;
a first USP, embedded in the electronic device body and configured to connect to a first electronic device;
a second USP, embedded in the electronic device body and configured to connect to a second electronic device;
a DSP, embedded in the electronic device body and configured to connect to a third electronic device;
a first control unit, located in the electronic device body and connected to the first USP and the DSP, to select whether to bring the DSP into data communication with the first USP; and
a second control unit, located in the electronic device body and connected to the second USP and the DSP, to select whether to bring the DSP into data communication with the second USP.

9. The electronic device according to claim 8, wherein the first USP is configured to receive a setting instruction, and the first control unit is configured to select, based on the setting instruction, whether to bring the DSP into data communication with the first USP.

10. The electronic device according to claim 8, wherein the second USP is configured to receive a setting instruction, and the second control unit is configured to select, based on the setting instruction, whether to bring the DSP into data communication with the second USP.

11. The electronic device according to claim 8, wherein each of the first control unit and the second control unit comprises a media access control circuit and a physical layer transceiver connected to each other.

12. The electronic device according to claim 11, wherein in the first control unit, the media access control circuit is configured to control, based on a setting instruction, the physical layer transceiver to receive and transmit data through the first USP and the DSP selected by the first control unit.

13. The electronic device according to claim 11, wherein in the second control unit, the media access control circuit is configured to control, based on a setting instruction, the physical layer transceiver to receive and transmit data through the second USP and the DSP selected by the second control unit.

14. The electronic device according to claim 8, wherein the number of DSP is multiple, the first control unit is configured to select to bring at least one of the DSPs to communicate data with the first USP, and the second control unit is configured to select to bring the remaining DSPs into data communication with the second USP.
